(19) United States
(12) Patent Application Publication
(10) Pub. No.: US 2023/0220120 A1
(43) Pub. Date: Jul. 13, 2023

(54) MALTODEXTRIN SYRUP HAVING A DE LESS THAN 20 WHILE HAVING PROPERTIES LIKE A CORN SYRUP OF DE 30-45

(71) Applicant: Archer Daniels Midland Company, Decatur, IL (US)

(72) Inventors: Alain Destexhe, Decatur, IL (US); Volker Capitain, Decatur, IL (US); Sena Akeloglu, Decatur, IL (US)

(21) Appl. No.: 18/002,234

(22) PCT Filed: Jun. 17, 2021
(86) PCT No.: PCT/US2021/037961

§ 371 Date: Dec. 16, 2022

Related U.S. Application Data
(60) Provisional application No. 63/041,086, filed on Jun. 18, 2020.

(51) Int. Cl. C08B 30/18; A23L 29/30

(52) U.S. Cl. CPC C08B 30/18; A23L 29/35

(57) ABSTRACT

A new type of maltodextrin syrup is described having functional properties of a corn syrup having a DE of between 35-45 while having a DE value less than 20. In the most general embodiment, the syrup contains no more than 70% of total saccharides with a DP of less than 10 while at the same time having least 50% of the saccharides do have a DP of less than 10. The remainder of the saccharides have a DP of 10 or more. For those saccharides having a DP of less than 10 the distribution is weighted toward the higher end with saccharides having a DP of 5 to 9 being more than the saccharides having a DP of 1 to 4.

### CROSS-REFERENCE TO RELATED APPLICATIONS

This application is a national stage entry of International Application No. PCT/US21/037961, filed Jun. 17, 2021, which itself claims priority to U.S. Provisional Pat. Application No. 63/041,086, filed Jun. 18, 2020, each of the contents of the entirety of which are incorporated by this reference.

### FIELD OF THE INVENTION

The present invention relates to the field of dextrin syrups derived from starch than contain lower molecular weight saccharides, and more specifically to a maltodextrin syrup having a low dextrose equivalent (DE) value yet with functional properties of a corn syrup having higher DE values.

### BACKGROUND OF THE INVENTION

Government food regulatory agencies around the world have defined certain specifications required to identify and label food ingredients that contain carbohydrates derived from starch in one category or another. A liquid carbohydrate food stuff derived from starch containing solubilized mono and disaccharide sugars as well as oligosaccharides of three or more residues is generally called a syrup or more particularly a glucose syrup. For most regulatory bodies in Europe, a syrup that is derived from starch from corn or wheat that has a measured dextrose equivalent value (DE) of greater than 20 is referred to as a glucose syrup, or specifically as corn syrup or wheat syrup. If the syrup has a DE of less than 20 and contains higher molecular weight dextrins derived from starch hydrolysis it is called a maltodextrin syrup. Similarly, but with differences, in the United States the Food and Drug administration defines a corn syrup as a glucose containing syrup derived from starch hydrolysis and has regulations that require a food manufacturer to only consider the amount of mono and disaccharides in syrup when reporting the amount of “sugars” that are present.

Health conscious consumers may look closely at the ingredient labels for foods they consume and typically seek to avoid foods that contain high “sugar” content or that are labeled as containing “corn syrup” or “wheat syrup.” Correspondingly, syrup manufacturers endeavor to produce syrups that will satisfy the requirements of health-conscious consumers. This results in some problems for food manufacturers who include syrups in their foodstuffs, because conventional syrups like a corn syrup having a DE value 30-45 have functional properties such as viscosity, dry substance content, glass transition, hygroscopicity and stability that affect the functional qualities of the foodstuffs made with the corn syrup. Starch derived syrups having a low DE value, i.e., a DE value of less than 20 are more viscous, have a lower dry substance content in terms of dissolved solids, have a higher glass transition temperature and tend to lose stability by becoming cloudy or being degraded by microorganisms because of the lower dry substance content than contained in a typical corn syrup having a DE value of 30-45. With respect to viscosity, syrups having a DE of 30-45 with a dissolved solids content of 74-83% have a viscosity between about 3000 and 10,000 centipois (cP) when measured at 50° C.

Syrup manufacturers have been successful in producing syrups that have lower mono and disaccharide content than conventional glucose syrups that would reduce the amount of “sugar” that would have to be counted under U.S. regulations and that exhibit some, but not all not all, of the functional properties of viscosity, dry substance content, glass transition, hygroscopicity or retorgadation stability as conventional 40DE corn syrups. For example, syrups marketed by Tate & Lyle under the tradenames MALTOSWEET or MULTIVANTAGE, by Tereos Starch & Sweeteners under the tradenames MALDEXEL and MYLOSE 351, and by Ingredion under the tradename VERSASWEET and have some of these properties. Syrup version of these products either have low stability towards microbiological infections (due to low dry substance content) or a high tendency towards retrogradation (due to a high level of dextrins with a degree of polymerization of greater than 10 forming insoluble precipitates) and all have a DE value greater than 20. Those products that have a problem with retrogradation or microbiological contamination products are most often not sold as syrups, but rather are sprat dried and sold as solids that must be dissolved.

Some “low sugar” syrups (as sugar content is defined under U.S. regulatory law) have been described in various patent documents. U.S. Pat. No. 8,361,235 and its siblings describe syrups made using a combination of an alpha amylase and pullunase that have less than about 25%, on a dry weight basis, total mono- and di-saccharides; from 12% to 55%, on a dry weight basis, oligosaccharides with a degree of polymerization (DP) of 3; from 50% to about 80%, on a dry weight basis, oligosaccharides with a DP of from about 3 to about 4;. less than about 4.5%, on a dry weight basis, oligosaccharides with a DP of 5; and a ratio of DP2/DP5 of at least 4.2. These syrups are characterized primarily by having a relatively high content of DP3 and DP4 saccharides and relatively low content (less than 10%) of maltodextrins and dextrins greater than DP11. Similarly, JP JPH3-251173 and JP61205495 describe syrups made using a maltotriose transferase having a similar oligosaccharide distribution as the syrups described in U.S. Pat. No. 8,361,235 in terms of DP3 and DP4 content and low level of higher molecular weight dextrins greater than DP10 or 11. While these syrups have a viscosity and dissolved solids content similar to conventional DE30-45 corn syrups, all of these syrups have a high DE value much closer to DE40 than DE 20 and would therefore need to be labeled as corn syrups under European regulatory law.

There is a need in art to develop a maltodextrin syrup that has similar functional characteristics of a DE30-45 corn syrup, but which lacks the large amount of low molecular weight oligosaccharides that cause the DE value to exceed 20.

### SUMMARY OF THE INVENTION

The invention solves the problem of producing a maltodextrin syrup that has a dextrose equivalent value (DE) of less than 20 while having similar properties of viscosity, dry substance content, glass transition, hygroscopicity and microstability typically found in a conventional enzyme converted gluco syrup having a DE of 30-45

The solution is to limit the distribution of total saccharides having degree of polymerization (DP) of less than 10 so that no more than 70% of total saccharides in the syrup have a DP of less than 10 while at the same time assuring that least 50% of the saccharides do have a DP of less than 10. The remainder of the saccharides have a DP of 10 or more, i.e., the saccharides having a DP of 10 or more are 30% to 50% of the saccharides in the syrup. For those saccharides having a DP of less than 10 it is preferable to balance the distribution with weighting toward saccharides having a DP of 5 to 9 being more than the saccharides having a DP of 1 to 4. In typical embodiments saccharides having a DP of 5-9 are 30-40% of the saccharides in the syrup while those having a DP of 1-4 are less than 25% of saccharides in the syrup. In preferable embodiments, the syrup has no more than 15%, preferably no more than 12% more preferably no more than 8%, and most preferably no more than 5% of total mono and disaccharides. It is also preferable to balance the distribution of saccharides having a DP of less than 10 so that the syrups have more saccharides with a DP of 5-7 than saccharides with a DP of 3 or 4. In preferable embodiments, there is a higher content of saccharides with a DP of 5-7 and with a DP of 3 or 4. In most embodiments 25% to 35% of the saccharides have a have a DP of 5-7 while 12% to 24% of the saccharides have a DP of 3 or 4. In more specific embodiments 26-30% of the saccharides have a DP of 6 or 7. Typically the saccharides having a DP of 8 or 9 account for no more than 7% of the total saccharides in the syrup.

Characterized in other ways, describe herein are maltodextrin syrups derived from starch where the syrup has a DE value of less than 20 with a saccharide distribution that has 30-50% saccharides with a degree of polymerization of 10 or more and 50-70% with a degree of polymerization of less than 10.

In one characterization the saccharide distribution of the syrup has 5% to 12% total mono- and di-saccharides; 8% to 15% saccharides having a degree of polymerization of 3; 38-48% saccharides having a degree of polymerization of 4 to 9; and 30-48% saccharides having a degree of polymerization of 10 or more.

In another characterization the saccharide distribution of the syrup has 5% to 12% total mono- and di-saccharides; 14% to 25% saccharides having a degree of polymerization of 3 or 4; and 30-48% saccharides having a degree of polymerization of 10 or more.

In other characterizations the saccharide distribution of the syrup has 8% to 15% total mono- and di-saccharides; 27% to 55% saccharides having a degree of polymerization of 3 to 6; and 15% to 25% with a DP of 7 to 9.

In other characterizations the as saccharides with a DP of 5-9 are 30-40% of the saccharides in the syrup and saccharides with a DP of 1-4 as less than 25% of saccharides in the syrup.

In other characterizations, the syrup has no more than 15%, preferably no more than 12% more preferably no more than 8%, and most preferably no more than 5% of total mono and disaccharides.

In other characterizations there are more saccharides in the syrup with a DP of 5-7 than saccharides with a DP of 3 or 4.

In other characterizations 25% to 35% of the saccharides in the syrup have a have a DP of 5-7 and 12% to 24% of the saccharides have a DP of 3 or 4.

In other characterization the saccharides in the syrup having a DP of 8 or 9 are no more than 7% of the total saccharides in the syrup.

In other characterizations 25% to 35% of the saccharides in the syrup have a have a DP of 5-7 while 12% to 24% of the saccharides have a DP of 3 or 4.

In other characterizations 26-30% of the saccharides in the syrup have a DP of 6 or 7.

In preferred embodiments any of the forgoing syrups has a dissolved solids content of at least 70% wt/wt.

In most embodiment the syrups have a viscosity measured under any conditions that is plus or minus 50% of the viscosity a DE40 corn syrup measured under the same conditions.

Also provided is dry saccharide product obtained by evaporating or spray drying the forging syrups.

Also provided is a food product made by blending any of the syrups of the present invention with other food ingredients to form a foodstuff, especially confectionary and creamer foodstuffs.

### BRIEF DESCRIPTION OF THE DRAWINGS

FIG. 1 is a table that shows the saccharide profile change over time for the production of one example syrup of the present invention from corn starch. Hours refers to 24-hour clock time.

FIG. 2 is a table shows the saccharide profile change over time for the production of one example syrup of the present invention from wheat starch. Hours refers to elapsed time.

FIG. 3 is a table showing the saccharide profile obtained using different combinations of enzymes and conditions, including conditions where the initial liquefaction enzyme is not inactivated prior to treatment with other enzymes.

### DETAILED DESCRIPTION OF THE INVENTION

The present disclosure provides is a new type of syrup derived from starch that qualifies as maltodextrin syrup by various European food regulatory agencies because it has a DE value of less than 20 , and qualifies as a low sugar syrup under US regulatory labeling requirement due to a low mono and disaccharide content yet has properties very similar to a glucose syrup in terms of viscosity, dry substance content, glass transition, and hygroscopicity typically found in a conventional enzyme converted glucose syrup having a DE of 40.

One advantage of the solution described herein has is easy processing of confectionary goods (e.g., hard boiled and gelatin gums) while maintaining stability. Furthermore, the low DE syrups of the present invention can easily be dried by evaporation to form a dry composition containing the same saccharide distribution, or spray dried alone or in combination with other ingredients such as fat compounds typically blended with dry creamer products.

In exemplary embodiments, the syrups of the present invention are prepared by digestion of a conventional starch liquifact having a DE of 9-15 using a combination of an alpha-amylase and pullunase as saccharification enzymes, with the key factor being to carefully control the reaction time, temperature, and pH s selected to produce a syrup with the saccharide distribution as described above to obtain a measured DE value that is as close to 20 as possible without going over 20. In this regard it is important to monitor the DE during the digestion with the saccharification enzymes and to consider the method of measuring DE and the precision of the method so that the final DE of the syrup will be under 20 taking into consideration the largest possible variation in the measurement. For example, if the method used for DE measurement obtains a value that is accurate to +/- 0.2 DE units the reaction should be stopped no later than when the DE of syrup reaches 19.7. During the final saccharification process the DE should be monitored using a reliable generally accepted method accepted by regulatory authorities such as freezing point depression using the Lane-Eynon-10201 method (ref. ISO 5377).

Suitable alpha amylase and pullulanase enzymes that are commercially available and suitable for the present invention include those sold by the manufactures listed in the table below by their respective tradenames, type of enzyme and genetic source of the enzymes.

| | | | |
|---|---|---|---|
| Trade Name | Manufacturer | Enzyme type | Enzyme Source. |
| Liquizyme | Novozymes | themostable alpha amylase | Bacillus Licheniformis |
| Ban 480L | Novozymes | low temperature alpha amylase | Bacillus amyloliquefaciens |
| LpHera | Novozymes | thermostable alpha amylase | Bacillus Licheniformis |
| Spezyme LT | Dupont | low temperature alpha amylase | Bacillus Licheniformis |
| AMT 1,2L | Amano | alpha amylase | Microbacterium Imperiale |
| Thermolase GL 30 | Amano | alpha amylase | Geobacillus Stearothermophilus |
| Promozyme D6 | Novozymes | pullulanse | Bacillus Acidopulluliticus |
| Optimax L1000 | DuPont | pullulanse | Bacillus Deramificans |

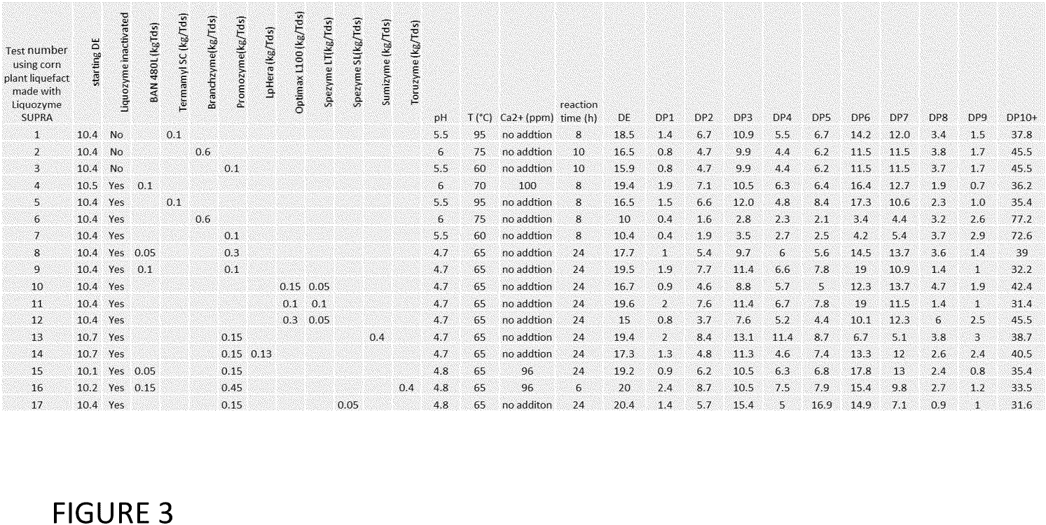

The starting material for the production of the syrups of the present invention is preferably a starch liquifact. As used herein a “liquifact” is a conventional type of liquid product obtained by treating starch with alpha-amylase and/or acid for a sufficient period to time to liquefy the starch so that all of the high molecular weight polysaccharides contained therein are dissolved in an aqueous solution. Typical liquifacts from corn or wheat starch have a dissolved solids content of 25% to 40% and DE value of 9 to 12.5. It is preferable to use a liquifact as the starting material with the initial alpha-amylase used being inactivated by heat treatment because the DE value and dextrin components will be stable. While it is preferable to use an inactivated liquifact as the starting material, it is possible to obtain a maltodextrin syrup of the present invention by using starch as the starting material and supplementing the initial liquefaction reaction by charging the reaction with additional starch hydrolytic enzymes once the DE value of the initial liquifact reaction reaches a desired starting point (preferably to a DE of 9-11). In any case, the DE of the syrup should be monitored during the final hydrolysis to be sure it does not exceed 20 before being subject to complete enzyme inactivation. Use of supplemental enzymes charged to an initial liquifact that has not been inactivated is illustrated in rows 1-3 in FIG. 3 described in Example 7 hereafter.

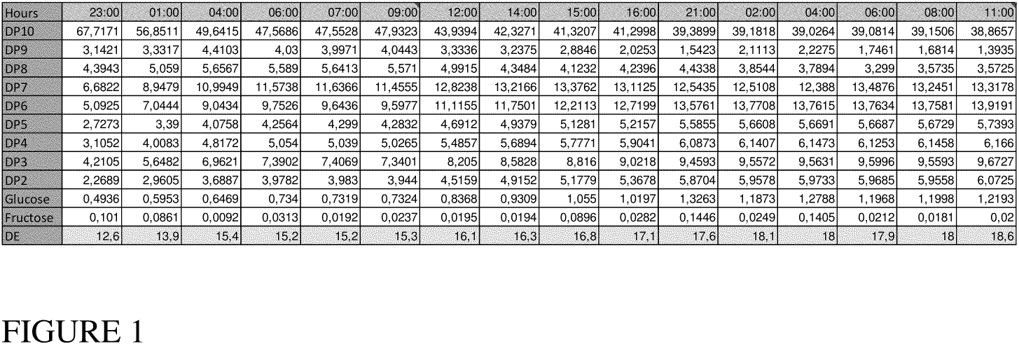

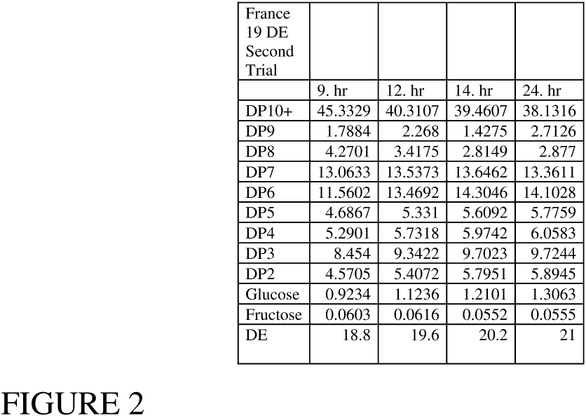

In the embodiments illustrated in the Examples that follow, the alpha amylase was BAN 48L0 and the pullunase was Promozyme D6. When using BAN 480L as the alpha amylase is enzymes it is critical to maintain the pH within a narrow range of 4.7 to 4.8. The reaction should contain 50- 100 ppm of a calcium salt such as CaCL₂. It is also critical to limit the time of digestion to prevent over saccharaification resulting in the production of a syrup with a DE that exceeds 20. The source of the starch may affect the reaction time as does the amount of enzyme. Using a corn starch Liquifact with a starting DE value of 9.8 and further digesting it with combination of BAN 480 L and Promozyme D6 at a dose of 0.05 and 0.15 kg/Tds, respectively, the reaction took 24 hours before the DE was raised to 18.6 (see FIG. 1). On the other hand, when using a wheat starch liquifact with a staring DE value of 10 further digesting it with combination of BAN 480 L and Promozyme D6 at a dose of 0.1 and 0.15 kg/Tds, respectively, the reaction took only 9 hours to reach a DE value of 18.8 and by 12 the DE was raised to 19.6 (see FIG. 2).

The dose of saccharification enzymes should be selected to optimize the need to control the reaction to make a reproducible product and to lower the cost of production. Higher enzyme loads result in faster saccharification but are more difficult to reproduce and cost more due to the higher enzyme expense. On the other lower enzyme loads are easier to reproduce and cost less but take more time to achieve the desired result. In various reactions BAN 480L was used at a dose of between 0.05 and 5 kg ds/T and preferably the dose was 0.1-0.3 kg ds/T. Prmozyme D2 was used between 0.1 and 1 kg ds/T and preferably the dose was 0.2-0.6 kg ds/T. The preferred reaction temperature is between 62° C. and 68° C., most preferably 64° C.-65° C.

The reaction with the saccharification enzymes should be halted when the syrup reaches the desired DE value. Inactivation of the saccharification enzymes is effectively achieved by lowering the pH to below 4 raising the temperature of the reaction to 90° C. or higher for a period of 0.2 to 0.5 hours.

While most of the work done for the present invention focused on use of a combination of alpha-amylase and pullunase, and most focused on use of BAN 480L as the alpha amylase and Promozyme D2 as the pullunase, other combinations of enzymes were also shown to be suitable for producing the low DE maltodextrin syrups of the present invention. Other enzymes tested include, Branchzyme (Novozymes), Termamyl SC (Novozymes), Optimax L1000 (Dupont), Spezyme LT (Dupont), LpHera (Novozymes), Sumizyme (Takabio)m Spezyme SL (Dupont), AMT 1.2 L (Amano)m Toruzyme. Some of these enzyme were tested in combination with the initial alpha-amylase enzyme (Liquozyme Supra enzyme, (Novozymes)) used to form the initial liquifact for subsequent treatment hydrolysis with the added enzyme, but without first inactivating the initial alpha enzymes. The results shown in FIG. 3 demonstrate that a maltodextrin syrup of the present invention can be made by several combinations of enzymes used under various reaction conditions.

### Example 1

### Laboratory Trial

A starch liquifact having a DE value 9.8 and a dissolved solids content of 34.85% was incubated with Promozyme D2 and BAN 480L at 65.9° C. in an aqueous mixture containing about 100 ppm Ca⁺² at a pH of 4.8. The enzyme dose was Promozyme D2 at 0.45 kg/ton of dry solids (“kg/Tds”) in the liquifact and BAN 480L at 0.15 kg/Tds. Tons in this, and all example is metric tons.

After 3 hours the pH dropped to 4.5 and the DE was raised to 16 so the pH was adjusted again to 4.8 and the mixture was recharged with a second dose of the same enzyme as at the beginning. After 3 hours further incubation the DE reached to 19.7 after which the enzymes were inactivated by decreasing the pH to 4 and heating at 90° C. for 15 min. The syrup was refined by rotary vacuum filtration and a double pass over a strong acid cation / weak base anion resin and concentrated to a dissolved solids content of 75%. The saccharide distribution of the resulting syrup was assessed by HPLC over a BIO-RAD, Aminex HPX-42 column and measured using a refractive index detector. The percent of saccharides with different degrees of polymerization that was obtained is shown below.

| | | | | | | | | | Glucose | Fructose |
|---|---|---|---|---|---|---|---|---|---|---|
| DP10+ | DP9 | DP8 | DP7 | DP6 | DP5 | DP4 | DP3 | DP2 | DP1 | |
| 33.84 | 1.09 | 3.38 | 13.01 | 15.51 | 6.38 | 6.63 | 10.4 | 6.88 | 1.52 | 0.02 |

The same process was repeated 7 times with variations in time and enzyme dose and stopping the reaction by inactivation when the DE reached between 18.5 and 19.8. The table below shows the range of saccharide values obtained.

| | DP10+ | DP9 | DP8 | DP7 | DP6 | DP5 | DP4 | DP3 | DP2 | DP1 |
|---|---|---|---|---|---|---|---|---|---|---|
| Range | 23-35 | 1-2 | 1-5 | 5-15 | 13-25 | 5-12 | 4-8 | 8-15 | 5-11 | 1-4 |
| Average | 33 | 1 | 2.3 | 11.2 | 19 | 7.6 | 6.4 | 11.1 | 7.2 | 1.5 |

### Example 2

### Plant Trial 1- Corn

A corn starch slurry with at 35% starch solids content was liquefied using a thermostable alpha amylase from B. Licheniformis sold under the tradename LIQUOZYME SUPRA 2.2X (Novozymes, Bagvaerd, Denmark). The dose was 0.24 to 0.30 kg/Tds at a pH 5.4. The enzyme treated slurry (300 cubic meterswas flash cooked through a jet cooker at a temperature of 106° C. over a 8.5-minute period. After the flash cooking, a second liquefaction was performed under the same enzyme at 99° C. for 3 to 3.5 hours. The final liquefact obtained had a DE of 10.3 and was inactivated by heating to 110° C. at a pH of 4.2 to 4.3.

Thereafter, the liquefact was cooled to 64° C., transferred to a saccharification tank and the pH adjusted to 4.8. The liquifact was further digested by treating with a combination of BAN 480L (a low temperature alpha amylase) and Promozyme D2 (a pullulanase) which were added at a dose of 0.05 and 0.15 kg/Tds, respectively. The reaction was allowed to proceed over a 24-hour period at temperature that was kept within the range of 64-65° C. and the pH was continuously monitored and adjusted stay within the range of 4.7 - 4.8.

FIG. 1 shows the saccharide development and DE values over a time course. A DE of 18.6 (calculated by freezing point depression) was reached after 24 hours at which time the pH was dropped to 3.4 to stop the enzymatic reaction. The product was passed over a rotary vacuum filter with a Perlite precoat. The fluxes are 3001/m2/h. Thereafter, the produced was passed over a CSEP (double pass first over strong acid and then weak base anion exchange reins). Further polishing was done by passing over a mixed bed resin with a weak acid cation and weak base anion resin. The product was evaporated to 78.6% ds. The final saccharide distribution obtained after 24 hours is shown below:

| DP10+ | DP9 | DP8 | DP7 | DP6 | DP5 | DP4 | DP3 | DP2 | DP1 |
|---|---|---|---|---|---|---|---|---|---|
| 38.90 | 1.40 | 3.60 | 13.30 | 13.90 | 5.70 | 6.20 | 9.70 | 6.10 | 1.20 |

The viscosity or the final syrup was measured using the Höpler method at different temperatures with the following results

| | |
|---|---|
| 20° C. | 160690 mPas |
| 40° C. | 13750 mPas |
| 60° C. | 2480 mPas |

To determine stability against retrogradation turbidity was measured by spectroscopic light scatter at 720 nm filtered-unfiltered with 0.45 um filter at 50°Bx) which had showed a value of 67.9 and the color was measured at absorbance at 420, which had a value of Colour (Icumsa) of 29.4.

### Example 3

### Plant Trial 2 - Corn

The process for creating a liquefact and further digestion to produce a maltodextrin described in Example 2 was repeated a second time as fully described therein with only slight changes in results. The starting liquifact had a DE of 9.8 and the final sample was evaporated to a dissolve solids content of 74.7%. The final resulting saccharide distribution is sown below.

| DP10+ | DP9 | DP8 | DP7 | DP6 | DP5 | DP4 | DP3 | DP2 | DP1 |
|---|---|---|---|---|---|---|---|---|---|
| 33.8 | 1.1 | 3.4 | 13.1 | 15.5 | 6.4 | 6.6 | 10.4 | 6.9 | 1.5 |

The viscosity at 50° C. was 3660 mPas as measured using the Brookfield method. The color absorbance a 420 nm (Icumsa) was 30, and the turbidity at 720 nm (unfiltered-filtered over 10 micron)(Icumsa)was 67.8. After 30 days the turbidity was 12.01 and the color was 21 indicating the syrup is stable against retrogradation.

### Example 4

### Plant Trial 3 - Corn

The process for creating a liquefact and further digestion to produce a maltodextrin described in Example 2 was repeated a second time as fully described therein with only slight changes in results. The starting liquifact had a DE of 10.5 and the final sample was evaporated to a dissolve solids content of 76.1%. The final resulting saccharide distribution is sown below.

| DP10+ | DP9 | DP8 | DP7 | DP6 | DP5 | DP4 | DP3 | DP2 | DP1 |
|---|---|---|---|---|---|---|---|---|---|
| 38.19 | 1.57 | 3.12 | 12.81 | 13.98 | 6.06 | 6.48 | 10.05 | 6.37 | 1.36 |

The viscosity measured by Brookfield at 50° C. was 4960 mPas.

### Example 5

### Plant Trial 4 - Wheat

A wheat starch slurry with at 35% starch solids content was liquefied using a thermostable alpha amylase from B. Licheniformis sold under the tradename LPHERA SUPRA 2.2X (Novozymes). The dose was 0.08-0.1 kg/Tds at pH 4.7. The enzyme treated slurry 350 cubic meters) was flash cooked through a jet cooker at a temperature of 105° C. over a 6-minute period. After the flash cooking, a second liquefaction was performed under the same enzyme at 99° C. for 160 minutes. The final liquefact obtained had a DE of 10.8 and was inactivated by heating to 99° C. at a pH of 3.

Thereafter, the liquefact was cooled to 63° C., transferred to a saccharification tank and the pH adjusted to 4.9 +/-1. The liquefact was further digested by treating with a combination of BAN 480L (a low temperature alpha amylase) and Promozyme D2 (a pullulanase) which were added at a dose of 0.1 and 0.15 kg/Tds, respectively..The reaction was allowed to proceed over a 24 hour period at a temperature that was kept within the range of 63 to 60° C. and the pH was continuously monitored and adjusted stay within the range of 4.7 - 4.8 The reaction was stopped by lowering the pH to 3.5 and heating to 9999° C. for 30 minutes.

FIG. 2 shows the saccharide development and DE values over a time course. A syrup suitable for use in the present invention having DE value less that 20 was obtained at least as early as 9 hours but begins to exceed a DE of 20 by 14 hours.

### Example 6

### Plant Trial 5 -Wheat

A syrup was prepared from a wheat liquefact as described in example 5 except the reaction was stopped after 7 hours by dropping the pH to 4.3 and heating to inactivate the enzymes. A syrup having a DE of 19.4 was obtained. A partial saccharide profile measuring only the amount of DP1through DP3 sugars showed the following results:

| | |
|---|---|
| Dextrose | 1.05% |
| Maltose | 5.7% |
| Maltotriose | 10.3% |
| Higher sugars | 83.0% |

The syrup was therefore very similar to those obtained from corn starch with respect to DP1 through DP3 saccharides so a full saccharide profile should reveal the higher sugars also have a similar distribution as the syrups obtained from corn starch.

### Example 7

### Alternative Enzyme Combinations

Several commercially available enzymes were tested for the ability to form a maltodextrin syrup having a DE of less than 20 and oligosaccharide profile that would give it the properties of conventional corn syrup having a DE value 30-45. FIG. 3 shows results obtained from laboratory test of various enzymes starting with a liquifact prepared as described in Example 2. The tradename of the enzymes tested, and their dosage are shown in the table along with the starting DE value, pH, amount of calcium added, temperature, time of the reaction, resulting DE value and saccharide distribution. For test numbers 1-3 the Liquozyme Supra alpha amylase from Novozymes used to form the starting liquifact was not inactivated, but merely supplemented with the additional tested enzyme after the DE reach the indicated value.

What is claimed is:

1. A saccharide syrup derived from starch where the syrup has a DE value of less than 20 with a saccharide distribution that has 30-50% saccharides with a degree of polymerization of 10 or more and 50-70% with a degree of polymerization of less than 10.

2. The saccharide syrup of claim 1 wherein the saccharide distribution has
5% to 12% total mono- and di-saccharides;
8% to 15% saccharides having a degree of polymerization of 3;
38-48% saccharides having a degree of polymerization of 4 to 9; and
30-48% saccharides having a degree of polymerization of 10 or more.

3. The saccharide syrup of claim 1 wherein the saccharide distribution has
5% to 12% total mono- and di-saccharides;
14% to 25% saccharides having a degree of polymerization of 3 or 4; and
30-48% saccharides having a degree of polymerization of 10 or more.

4. The saccharide syrup of claim 1 wherein the saccharide distribution has
8% to 15% total mono- and di-saccharides;
27% to 55% saccharides having a degree of polymerization of 3 to 6; and
15% to 25% with a DP of 7 to 9.

5. The saccharide syrup of any one of claims 1-4 having a having a viscosity measured under any conditions that is within 10% of the viscosity of a DE40 corn syrup measured under the same conditions.

6. The saccharide syrup of claim 1 wherein saccharides with a DP of 5-9 are 30-40% of the saccharides in the syrup and saccharides with a DP of 1-4 as less than 25% of saccharides in the syrup.

7. The saccharide syrup of claim 1 wherein, the syrup has no more than 15%, preferably no more than 12% more preferably no more than 8%, and most preferably no more than 5% of total mono and disaccharides.

8. The saccharide syrup of claim 1 wherein there are more saccharides with a DP of 5-7 than saccharides with a DP of 3 or 4.

9. The saccharide syrup of claim 1 wherein 25% to 35% of the saccharides have a have a DP of 5-7 and 12% to 24% of the saccharides have a DP of 3 or 4.

10. The saccharide syrup of claim 1 wherein the saccharides having a DP of 8 or 9 are no more than 7% of the total saccharides in the syrup.

11. The saccharide syrup of claim 1 wherein 25% to 35% of the saccharides have a have a DP of 5-7 while 12% to 24% of the saccharides have a DP of 3 or 4.

12. The saccharide syrup of claim 1 wherein 26-30% of the saccharides have a DP of 6 or 7.

13. The saccharide syrup of any one of claims 1-12 where the syrup has a dissolved solids content of at least 70% wt/wt.

14. The saccharide syrup of claim 13 wherein the syrup has a viscosity value in centipois that is plus or minus 50% of the viscosity of the viscosity value measured for a DE40 corn syrup under the same conditions of dissolved solids content ant temperature.

15. A dry saccharide product obtained by evaporating the syrup according to any one of claims 1-13 to a dry state.
